(19) United States
(12) Patent Application Publication
(10) Pub. No.: US 2014/0092244 A1
(43) Pub. Date: Apr. 3, 2014

(54) OBJECT SEARCH METHOD, SEARCH VERIFICATION METHOD AND APPARATUSES THEREOF

(71) Applicant: NEC (China) Co., Ltd., Beijing (CN)

(72) Inventors: Shaopeng Tang, Beijing (CN); Dawei Liang, Beijing (CN); Wei Zeng, Beijing (CN)

(73) Assignee: NEC (China) Co., Ltd., Beijing (CN)

(21) Appl. No.: 13/954,338

(22) Filed: Jul. 30, 2013

(30) Foreign Application Priority Data
Sep. 29, 2012 (CN) CN201210376145.2

(51) Int. Cl. H04N 7/18

(52) U.S. Cl. CPC H04N 7/18
USPC 348/143

(57) ABSTRACT

An object search method, a search verification method, and apparatuses thereof, pertain to the field of video surveillance technologies. The object search method includes: acquiring an object image for search and a designated region of the object image for search, and calculating local feature points in the designated region of the object image for search; searching in a pre-constructed index set for indexes matching the local feature points in the designated region; and acquiring object images corresponding to the detected indexes, and using the acquired object images as detected object images in a video. In this way, object search is implemented by using local regions of an image, the application range of the object search is extended, and accuracy of the search result is improved.

### FIELD OF THE INVENTION

The present invention relates to the field of video surveillance technologies, and in particular, relates to an object search method, a search verification method, and apparatuses thereof.

### BACKGROUND OF THE INVENTION

With constant development of video technologies, video surveillance is becoming more and more widely applied. During management of captured videos, searching designated objects in a video is a problem to be solved and a subject for research.

In the prior art, when searching objects in a video, one method is to determine the dominant color of an object image for search, and search in a captured video for object images with the same dominant color as the object image for search. Another method is to calculate the color histogram of an object image for search, measure the matching degree between each of the images captured in the video and the object image for search according to the color histogram, and acquire a search result accordingly.

During the implementation of the present invention, the inventors find that the prior art has at least the following problems:

Since the color histogram only reflects a global matching degree between images, the application range of the method for searching objects by using the color histogram has its limitation to some extent. In addition, the color of an object is greatly subject to factors such as illumination and the like, and fails to fully embody features of the object. Therefore, when external conditions, such as illumination, change, effective object searching fails and hence accuracy of the search result is poor, regardless of searching objects by using color distribution of an object or searching objects by using the color histogram.

### SUMMARY OF THE INVENTION

To solve the problems in the prior art, embodiments of the present invention provide an object search method, a search verification method, and apparatuses thereof. The technical solutions are as follows:

In one aspect, an object search method is provided, where the method includes:

acquiring an object image for search and a designated region of the object image for search, and calculating local feature points in the designated region of the object image for search, where the designated region is a discriminative region;

searching in a pre-constructed index set for index(es) matching the local feature points in the designated region, where the index set is constructed according to local feature points in object images in a video; and

acquiring object image(s) corresponding to the detected indexes, and using the acquired object image(s) as object image(s) detected in the video.

Furthermore, prior to the searching in a pre-constructed index set for index(es) matching the local feature points in the designated region, the method further includes:

acquiring object images in a video, and calculating local feature points in the object images; and

clustering the acquired local feature points, and constructing an index set by using local feature points at clustering centers as indexes.

Particularly, the searching in a pre-constructed index set for index(es) matching the local feature points in the designated region specifically includes:

clustering the local feature points in the designated region with the local feature points in the index set, and using the local feature points, which fall into the same category as the local feature points in the designated region, in the index set as the detected index(es) matching the local feature points in the designated region.

Furthermore, after the acquiring object image(s) corresponding to the detected index(es), and using the acquired object image(s) as object image(s) detected in the video, the method further includes:

acquiring each local feature point in the designated region and the corresponding local feature point of each of the detected object image(s) to obtain a local feature point pair;

calculating an angle difference between two local feature points in each of the local feature point pairs, and determining a primary angle difference in the calculated angle differences; and

calculating a distance from each of the angle differences to the primary angle difference, and verifying the detected object image(s) according to the distances.

Alternatively, after the acquiring object image(s) corresponding to the detected index(es), and using the acquired object image(s) as object image(s) detected in the video, the method further includes:

acquiring each local feature point in the designated region and the corresponding local feature point of each of the detected object image(s) to obtain a local feature point pair;

calculating an angle difference between two local feature points in each of any two local feature point pairs, and calculating an angle formed by a line segment pair formed by the any two local feature point pairs;

judging whether the calculated angle differences are equal to the angle formed by the line segment pair, and if the calculated angle differences are equal to the angle formed by the line segment pair, using the any two local feature point pairs as matched local feature point pairs; and

counting the number of matched local feature point pairs in the detected object image(s), and verifying the detected object image(s) according to the number of matched local feature point pairs in the detected object image(s).

Furthermore, after the acquiring an object image for search, the method further includes:

displaying the object image for search, and the designated region of the object image for search.

Furthermore, after the acquiring object image(s) corresponding to the detected index(es), and using the acquired object image(s) as object image(s) detected in the video, the method further includes:

displaying the detected object image(s).

Furthermore, the method further includes:

displaying the object image(s) passing verification.

In another aspect, an object search apparatus is provided, where the apparatus includes:

a first acquiring module, configured to acquire an object image for search and a designated region of the object image for search, where the designated region is a discriminative region;

a calculating module, configured to calculate local feature points in the designated region of the object image for search acquired by the first acquiring module;

a detecting module, configured to search in a pre-constructed index set for index(es) matching the local feature points in the designated region calculated by the calculating module, where the index set is constructed according to local feature points in object images in a video; and

a second acquiring module, configured to acquire object image(s) corresponding to the index(es) detected by the detecting module, and use the acquired object image(s) as object image(s) detected in the video.

Furthermore, the apparatus further includes:

an index set constructing module, configured to: acquire object images in a video, and calculate local feature points in the object images; and cluster the acquired local feature points, and construct an index set by using local feature points at clustering centers as indexes.

The detecting module is specifically configured to cluster the local feature points in the designated region with the local feature points in the index set, and use the local feature points, which fall into the same category as the local feature points in the designated region, in the index set as the detected index(es) matching the local feature points in the designated region.

Furthermore, the apparatus further includes:

a first verifying module, configured to: acquire each local feature point in the designated region and the corresponding local feature point in each of the detected object image(s) to obtain a local feature point pair; calculate an angle difference between two local feature points in each of the local feature point pairs, and determine a primary angle difference in the calculated angle differences; and calculate a distance from each of the angle differences to the primary angle difference, and verify the detected object image(s) according to the distances.

Alternatively, the apparatus further includes:

a second verifying module, configured to: acquire each local feature point in the designated region and the corresponding local feature point of each of the detected object image(s) to obtain a local feature point pair; calculate an angle difference between two local feature points in each of any two local feature point pairs, and calculate an angle formed by a line segment pair formed by the any two local feature point pairs; judge whether the calculated angle differences are equal to the angle formed by the line segment pair, and if the calculated angle differences are equal to the angle formed by the line segment pair, use the any two local feature point pairs as matched local feature point pairs; and count the number of matched local feature point pairs in the detected object image(s), and verify the detected object image(s) according to the number of matched local feature point pairs in the detected object image(s).

Furthermore, the apparatus further includes:

a first GUI, configured to display the object image for search, and the designated region of the object image for search acquired by the first acquiring module.

Furthermore, the apparatus further includes:

a second GUI, configured to display the object image(s) acquired by the second acquiring module.

Furthermore, the apparatus further includes:

a third GUI, configured to display the object image(s) successfully verified by the first verifying module and the second verifying module.

In one aspect, a search verification method is provided, where the method includes:

acquiring each local feature point in a designated region of an object image for search and the corresponding local feature point of each of detected object image(s) to obtain a local feature point pair, where the designated region is a discriminative region;

calculating an angle difference between two local feature points in each of any two local feature point pairs, and calculating an angle formed by a line segment pair formed by the any two local feature point pairs;

judging whether the calculated angle differences are equal to the angle formed by the line segment pair, and if the calculated angle differences are equal to the angle formed by the line segment pair, using the any two local feature point pairs as matched local feature point pairs; and

counting the number of matched local feature point pairs in the detected object image(s), and verifying the detected object image(s) according to the number of matched local feature point pairs in the detected object image(s).

Furthermore, prior to the acquiring each local feature point in a designated region of an object image for search, and the corresponding local feature point of detected object image(s), the method further includes:

acquiring the object image for search and the designated region of the object image for search, and calculating the local feature points in the designated region of the object image for search;

searching in a pre-constructed index set for index(es) matching the local feature points in the designated region, where the index set is constructed according to local feature points in object images in a video; and

acquiring object image(s) corresponding to the detected index(es), and using the acquired object image(s) as object image(s) detected in the video.

Furthermore, prior to the searching in a pre-constructed index set for index(es) matching the local feature points in the designated region, the method further includes:

acquiring object images in a video, and calculating local feature points in the object images; and

clustering the acquired local feature points, and constructing an index set by using local feature points at clustering centers as indexes.

Particularly, the searching in a pre-constructed index set for index(es) matching the local feature points in the designated region specifically includes:

clustering the local feature points in the designated region with the local feature points in the index set, and using the local feature points, which fall into the same category as the local feature points in the designated region, in the index set as the detected index(es) matching the local feature points in the designated region.

Furthermore, after the acquiring an object image for search, the method further includes:

displaying the object image for search, and the designated region of the object image for search.

Furthermore, after the acquiring object image(s) corresponding to the detected index(es), and using the acquired object image(s) as object image(s) detected in the video, the method further includes:

displaying the detected object image(s).

Furthermore, after the verifying the detected object image(s) according to the number of matched local feature point pairs in the detected object image(s), the method further includes:

displaying the object image(s) passing verification.

In another aspect, a search verification apparatus is provided, where the apparatus includes:

a first acquiring module, configured to acquire each local feature point in a designated region of an object image for search and the corresponding local feature point in each of detected object image(s) to obtain a local feature point pair, where the designated region is a discriminative region;

a calculating module, configured to calculate an angle difference between two local feature points in each of any two local feature point pairs acquired by the first acquiring module, and calculate an angle formed by a line segment pair formed by the any two local feature point pairs;

a judging module, configured to judge whether the angle differences calculated by the calculating module are equal to the angle formed by the line segment pair;

a verifying module, configured to: if the calculated angle differences are equal to the angle formed by the line segment pair, use the any two local feature point pairs as matched local feature point pairs; count the number of matched local feature point pairs in the detected object image(s); and verify the detected object image(s) according to the number of matched local feature point pairs in the detected object image(s).

Furthermore, the apparatus further includes:

a searching module, configured to: acquire an object image for search and a designated region of the object image for search, and calculate local feature points in the designated region of the object image for search; search in a pre-constructed index set for index(es) matching the local feature points in the designated region, where the index set is constructed according to local feature points in object images in a video; and acquire object image(s) corresponding to the detected index(es), and use the acquired object image(s) as object image(s) detected in the video.

Furthermore, the apparatus further includes:

an index set constructing module, configured to: acquire object images in a video, and calculate local feature points in the object images; and cluster the acquired local feature points, and construct an index set by using local feature points at clustering centers as indexes.

The searching module is specifically configured to: cluster the local feature points in the designated region with the local feature points in the index set, and use the local feature points, which fall into the same category as the local feature points in the designated region, in the index set as the detected index(es) matching the local feature points in the designated region.

The technical solutions provided in the embodiments of the present invention achieve the following beneficial effects:

According to the object search method, one or more object images are detected in a video by using local feature points in a designated region of an object image for search, and the designated region is a discriminative region. In this way, object search is implemented by using local regions of image(s). In addition, since calculation of the local feature points is not subject to external factors such as illumination and the like, such that the object is effectively detected in the video, and accuracy of the search result is improved.

According to the search verification method, an angle difference between two local feature points in each of any two local feature point pairs, and an angle formed by a line segment pair formed by the any two local feature point pairs are calculated, matched local feature point pairs are acquired accordingly, and then the one or more detected object images are verified according to the number of matched local feature points pairs. In this way, under the premise of reducing calculation complexity, a relative location relationship between the local feature points is effectively used, and thus verification performance is improved.

### BRIEF DESCRIPTION OF DRAWINGS

For a better understanding of the technical solutions in the embodiments of the present invention, the accompanying drawings for illustrating the embodiments are briefly described below. Evidently, the accompanying drawings in the following description illustrate only some embodiments of the present invention, and a person skilled in the art can derive other accompanying drawings from these accompanying drawings without any creative efforts.

FIG. 1 is a flowchart of an object search method according to Embodiment 1 of the present invention;

FIG. 2 is a flowchart of a search verification method according to Embodiment 1 of the present invention;

FIG. 3 is a flowchart of an object search method according to Embodiment 2 of the present invention;

FIG. 4 is a schematic diagram of an interface for object search according to Embodiment 2 of the present invention;

FIG. 5 is a schematic diagram of image matching according to Embodiment 2 of the present invention;

FIG. 6 is a schematic diagram of angle difference distribution according to Embodiment 2 of the present invention;

FIG. 7 is a schematic diagram of a point pair according to Embodiment 2 of the present invention;

FIG. 8 is a flowchart of a search verification method according to Embodiment 3 of the present invention;

FIG. 9 is a schematic structural diagram of a first object search apparatus according to Embodiment 4 of the present invention;

FIG. 10 is a schematic structural diagram of a second object search apparatus according to Embodiment 4 of the present invention;

FIG. 11 is a schematic structural diagram of a third object search apparatus according to Embodiment 4 of the present invention;

FIG. 12 is a schematic structural diagram of a fourth object search apparatus according to Embodiment 4 of the present invention;

FIG. 13 is a schematic structural diagram of a first search verification apparatus according to Embodiment 5 of the present invention;

FIG. 14 is a schematic structural diagram of a second search verification apparatus according to Embodiment 5 of the present invention; and

FIG. 15 is a schematic structural diagram of a third search verification apparatus according to Embodiment 5 of the present invention.

### DETAILED DESCRIPTION OF THE EMBODIMENTS

To make the objectives, technical solutions, and advantages of the present invention more understandable, the embodiments of the present invention are described in detail below with reference to the accompanying drawings.

### Embodiment 1

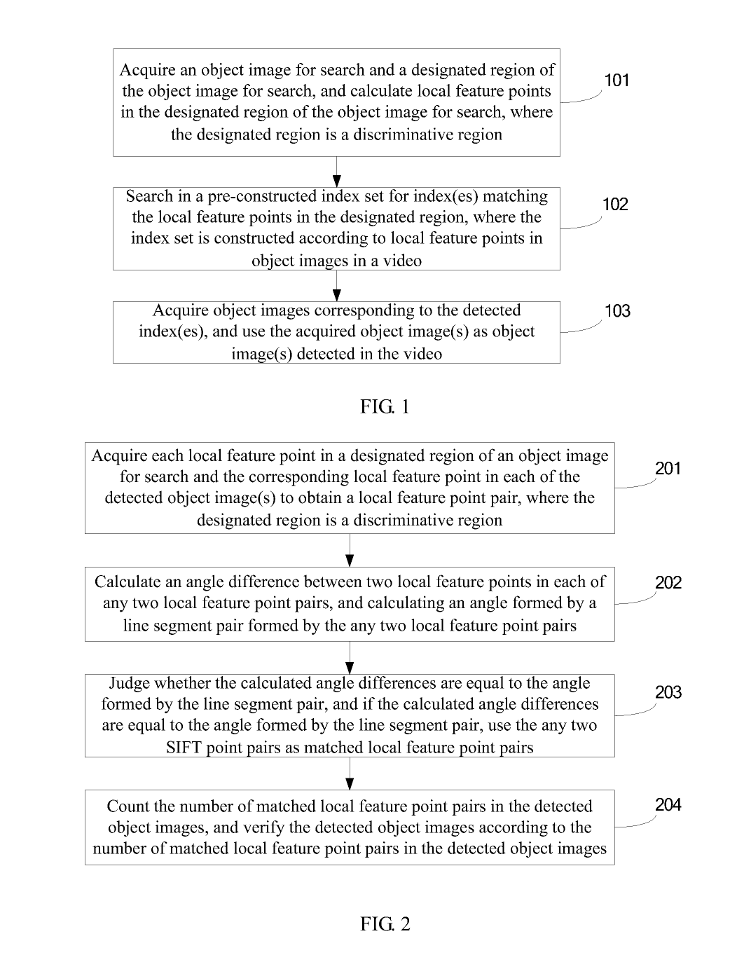

This embodiment provides an object search method. The method, by detecting object image(s) in a video by using local feature points in a designated region of an object image for search, implements object search by using a local region of an image. Referring to FIG. 1, the method provided in this embodiment includes the following steps:

101: Acquiring an object image for search and a designated region of the object image for search, and calculating local feature points in the designated region of the object image for search, where the designated region is a discriminative region.

102: Searching in a pre-constructed index set for index(es) matching the local feature points in the designated region, where the index set is constructed according to local feature points in object images in a video.

Furthermore, prior to the searching in a pre-constructed index set for indexes matching the local feature points in the designated region, the method further includes:

acquiring object images in a video, and calculating local feature points in the object images; and

clustering the acquired local feature points, and constructing an index set by using local feature points at clustering centers as indexes.

The searching in a pre-constructed index set for index(es) matching the local feature points in the designated region specifically includes:

clustering the local feature points in the designated region with the local feature points in the index set, and using the local feature points, which fall into the same category as the local feature points in the designated region, in the index set as the detected index(es) matching the local feature points in the designated region.

103: Acquiring object image(s) corresponding to the detected index(es), and using the acquired object image(s) as object image(s) detected in the video.

Furthermore, after the acquiring object image(s) corresponding to the detected index(es), and using the acquired object image(s) as object image(s) detected in the video, the method further includes:

acquiring each local feature point in the designated region and the corresponding local feature point in each of the detected object image(s) to obtain a local feature point pair;

calculating an angle difference between two local feature points in each of the local feature point pairs, and determining a primary angle difference in the calculated angle differences; and

calculating a distance from each of the angle differences to the primary angle difference, and verifying the detected object image(s) according to the distances.

Alternatively, after the acquiring object image(s) corresponding to the detected index(es), and using the acquired object image(s) as object image(s) detected in the video, the method further includes:

acquiring each local feature point in the designated region and the corresponding local feature point of each of the detected object image(s) to obtain a local feature point pair;

calculating an angle difference between two local feature points in each of any two local feature point pairs, and calculating an angle formed by a line segment pair formed by the any two local feature point pairs;

judging whether the calculated angle differences are equal to the angle formed by the line segment pair, and if the calculated angle differences are equal to the angle formed by the line segment pair, using the any two local feature point pairs as matched local feature point pairs; and

counting the number of matched local feature point pairs in the detected object image(s), and verifying the detected object image(s) according to the number of matched local feature point pairs in the detected object image(s).

Furthermore, after the acquiring an object image for search, the method further includes:

displaying the object image for search, and the designated region of the object image for search.

Furthermore, after the acquiring object image(s) corresponding to the detected index(es), and using the acquired object image(s) as object image(s) detected in the video, the method further includes:

displaying the detected object image(s).

Furthermore, the method further includes:

displaying the object image(s) passing verification.

In another aspect, an embodiment further provides a search verification method. Referring to FIG. 2, the search verification method according to this embodiment includes the following steps:

201: Acquiring each local feature points in a designated region of an object image for search and the corresponding local feature points in each of the detected object image(s), to acquire a local feature point pair, where the designated region is a discriminative region.

Furthermore, prior to the acquiring each local feature points in a designated region of an object image for search, and the corresponding local feature point of each of the detected object image(s), the method further includes:

acquiring the object image for search and the designated region of the object image for search, and calculating the local feature points in the designated region of the object image for search;

searching in a pre-constructed index set for index(es) matching the local feature points in the designated region, where the index set is constructed according to local feature points in object images in a video; and

acquiring object image(s) corresponding to the detected indexes, and using the acquired object image(s) as object image(s) detected in the video.

Furthermore, prior to the searching in a pre-constructed index set for index(es) matching the local feature points in the designated region, the method further includes:

acquiring object images in a video, and calculating local feature points in the object images; and

clustering the acquired local feature points, and constructing an index set by using local feature points at clustering centers as indexes.

The searching in a pre-constructed index set for index(es) matching the local feature points in the designated region specifically includes:

clustering the local feature points in the designated region with the local feature points in the index set, and using the local feature points, which fall into the same category as the local feature points in the designated region, in the index set as the detected index(es) matching the local feature points in the designated region.

202: Calculating an angle difference between two local feature points in each of any two local feature point pairs, and calculating an angle formed by a line segment pair formed by the any two local feature point pairs.

203: Judging whether the calculated angle differences are equal to the angle formed by the line segment pair, and if the calculated angle differences are equal to the angle formed by the line segment pair, using the any two local feature point pairs as matched local feature point pairs.

204: Counting the number of matched local feature point pairs in the detected object image(s), and verifying the detected object image(s) according to the number of matched local feature point pairs in the detected object image(s).

Furthermore, after the acquiring an object image for search, the method further includes:

displaying the object image for search, and the designated region of the object image for search.

Furthermore, after the acquiring object image(s) corresponding to the detected index(es), and using the acquired object image(s) as object image(s) detected in the video, the method further includes:

displaying the detected object image(s).

Furthermore, after the verifying the detected object image(s) according to the number of matched local feature point pairs in the detected object image(s), the method further includes:

displaying the object image(s) passing verification.

According to the object search method provided in this embodiment, one or more object images are detected in a video by using local feature points in a designated region of an object image for search, and the designated region is a discriminative region. In this way, object search is implemented by using local regions of an image. In addition, since calculation of the local feature points is not subject to external factors such as illumination and the like, such that the object is effectively detected in the video, and accuracy of the search result is improved.

According to the search verification method provided in this embodiment, an angle difference between two local feature points in each of any two local feature point pairs, and an angle formed by a line segment pair formed by the any two local feature point pairs are calculated, matched local feature point pairs are acquired accordingly, and then one or more detected object images are verified according to the number of matched local feature points pairs. In this way, under the premise of reducing calculation complexity, a relative location relationship between the local feature points is effectively used, and thus verification performance is improved.

For clear illustration of the object search method and the search verification method, with reference to the content disclosed in the above embodiment, Embodiments 2 and 3 are used as examples to describe the object search method and the search verification method. For details, reference may be made to Embodiments 2 and 3 as follows.

### Embodiment 2

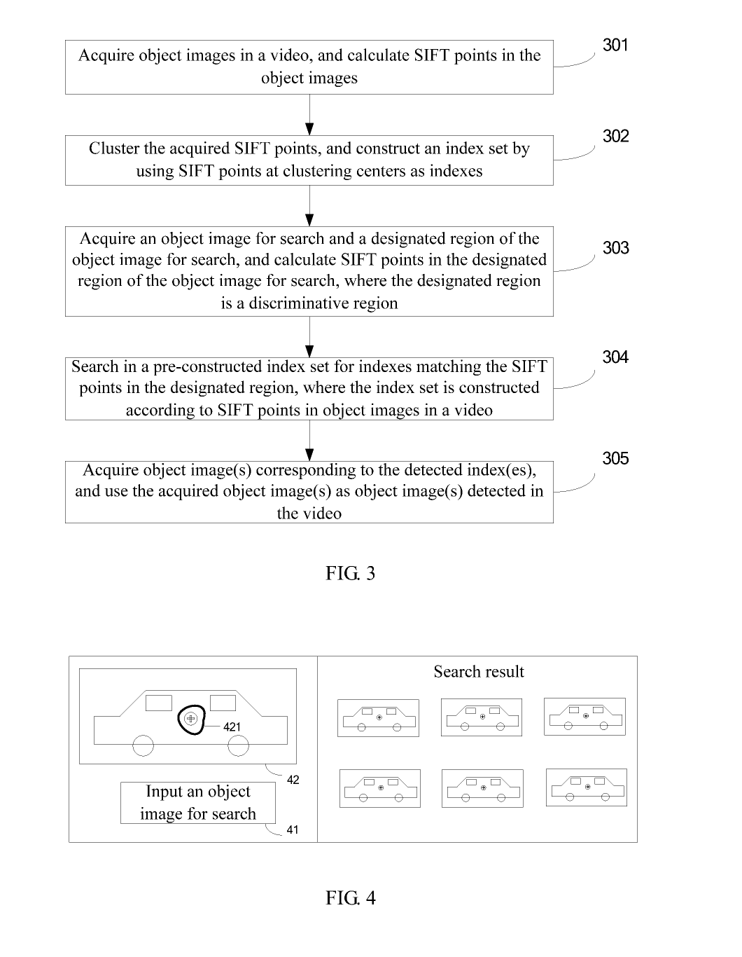

This embodiment provides an object search method. During object searching, an object image may include some discriminative local regions, and local feature points may be used to detect and depict local features of the object image. Therefore, to extend the application range of object search, the method provided in this embodiment, by searching an object image by using local feature points in a designated region in the object image for search, implements object search by using local regions of an image. With reference to the description in Embodiment 1, for ease of description, this embodiment uses scale-invariant feature transform (SIFT) points as an example. Referring to FIG. 3, the method provided in this embodiment includes the following steps:

301: Acquiring an object image in a video, and calculating SIFT points in the object image.

With respect to the specific implementation of this step, a video is first acquired, where the video may include various objects, including but not limited to trees, cars, buildings, and people. Secondly, after the video is acquired, the video is transformed into a corresponding image sequence, object detection is performed in each of images in the image sequence to acquire multi-frame object-containing images, and the images are identified by frame numbers. The identified multi-frame object-containing images are comprised of foreground images and background images, and the object images therein may be foreground images of the object-containing images. Information including coordinate, length and width is used to identify the object images. In this way, object images can be extracted from the object-containing images according to the information including coordinate, length and width; and then SIFT points are calculated for the extracted object images. In the prior art, there are known methods for calculating the SIFT points. Therefore, herein, the SIFT points can be calculated according to the calculation methods disclosed in the prior art, which is not described herein any further.

With respect to the method for acquiring a video, since video capturing devices have been widely used in various scenarios because of constant development of the video technologies, video capturing devices can be used to capture and acquire a lot of videos. Still since the acquired video can reflect scenario information within a specific range, the more videos are acquired, the more diversified the object images acquired from the videos, and the wider the object search range is. In this way, more videos are acquired. During specific implementation, this embodiment sets no limitation on the number of acquired videos and the number of object images.

302: Clustering the acquired SIFT points, and constructing an index set by using SIFT points at clustering centers as indexes.

With respect to this step, the acquired SIFT points can be clustered in a plurality of ways. The way employed in this embodiment includes but is not limited to: using the K-mean algorithm to cluster all acquired SIFT points. The specific process is as follows:

Firstly, K SIFT points are randomly selected from all the SIFT points as K categories of initial clustering centers, and a similarity between each of the SIFT points and the K initial clustering centers is calculated. To be specific, the similarity may be calculated by calculating a Euclidean distance or a Mahalanobis distance between each of the SIFT points and the K initial clustering centers, or by using another similar method for similarity calculation, which is not specifically limited in this embodiment.

Secondly, after the similarity between each of the SIFT points and the K clustering centers is calculated, the SIFT points are grouped into corresponding categories according to the similarities to acquire K categories, and a similarity between each two SIFT points in each category is calculated to re-obtain a clustering center of each category. In this way, SIFT points are successfully clustered.

Each of the acquired clustering centers is also a corresponding SIFT point, and the SIFT as the clustering center represents a category of SIFT points. The SIFT point in this category corresponds to a category of object images. Therefore, after a clustering center of each category is acquired, in this embodiment, an index set is constructed by using the SIFT points at the clustering centers as indexes, such that after the SIFT points are acquired according to the object images and then clustered, the SIFT points as the clustering centers are used as the indexes for searching object images in the corresponding categories. For example, the SIFT points in object images A, B, C, D, E, and F are respectively calculated and then clustered, object images A, B, C, and D correspond to the same clustering center SIFT point 1, and object images E and F correspond to the same clustering center SIFT point 2; after an index set is constructed by using

SIFT point 1 and SIFT point 2 as indexes, object images A, B, C, and D can be determined by querying SIFT point 1, and object images E and F can be determined by querying SIFT point 2.

It should be noted that, the process of constructing the index set described in steps 301 and 302 may be considered as a process of constructing a search database according to the videos. All videos are stored in a manner of index set such that object images corresponding to designated indexes are detected by using the index set. Therefore, steps 301 and 302 are prerequisites of object search, and can be performed prior to execution of the object search method. In addition, in the case that the video remains unchanged, when the object search method provided in this embodiment is being performed, steps 301 and 302 do not need to be performed repeatedly. To be specific, if the video remains unchanged, objects can be detected according to the same index set. However, if the video changes or a new video is acquired, steps 301 and 302 can be performed again to construct a corresponding index set.

303: Acquiring an object image for search and a designated region of the object image for search, and calculating SIFT points in the designated region of the object image for search, where the designated region is a discriminative region.

The object image for search may be designated by a user such that corresponding object images are detected in the video according to the object image designated by the user. During specific implementation, the method according to this embodiment can provide an interface for inputting the object images for search, i.e., a GUI. The user selects and inputs a corresponding object image for search over the input interface, the input object image is used as the acquired object image for search and the object image is displayed. After inputting the corresponding object image for search over the input interface, the user may also select a discriminative local region from the object image for search, for example, a pattern on clothes, and a logo and mounting bracket on a car, and use the selected local region as a designated region, such that the object is detected according to the SIFT points in the designated region in the subsequent steps. That is, the designated region is a discriminative region selected by a user over a GUI.

For ease of understanding, the case where an input interface illustrated in FIG. 4 is provided for a user, and the user selects and inputs a car as the object image for search over the provided input interface is used as an example for description. In FIG. 4, reference sign 41 denotes an option for inputting an object image for search; and after the user selects the option, performs an operation for inputting the object image for search, and the selected and input object image for search is acquired, the input interface displays an acquired object image 42 for search. Furthermore, the user may also mark a designated region 421 illustrated in FIG. 4 in the displayed object image 42 for search by using input devices such as a mouse. In this way, user's input operations are completed, processes of acquiring the user's input object image for search and user's designated region and calculating SIFT points in the designated region by using the conventional method for calculating SIFT points are triggered.

304: Searching in a pre-constructed index set for index(es) matching the SIFT points in the designated region, where the index set is constructed according to SIFT points in object images in a video.

Particularly, in this embodiment, the index(es) matching the SIFT points in the designated region can be detected in a pre-constructed index set by using various methods, including but noted limited to:

clustering the SIFT points in the designated region with the SIFT points in the index set, and using the SIFT points, which fall into the same category as the SIFT points in the designated region, in the index set as the detected SIFT points matching the SIFT points in the designated region.

The SIFT points in the designated region and the SIFT points in the index set can be clustered by using the clustering method described in step 302. To be specific, the SIFT points in the designated region and the SIFT points in the index set are clustered, and the SIFT point(s) which fall into the same category as the SIFT points in the designated region is(are) used as the detected index(es).

305: Acquiring object image(s) corresponding to the detected index(es), and using the acquired object image(s) as object image(s) detected in the video.

With respect to this step, since during construction of the index set in step 302, each index in the index set corresponds to a category of object images, the corresponding categories of object images can be acquired according to the detected index(es). Furthermore, since the detected index(es) are the SIFT points matching the SIFT points in the designated region, the object image(s) acquired according to the detected index(es) also include features in the designated region. In this way, the acquired object image(s) can be used as the object image(s) detected in the video, thereby acquiring a search result.

In addition, to inform the user about the search result, the method provided in this embodiment further supports displaying the detected object image(s). The detected object image(s) may be specifically displayed in various manners, including but not limited to: displaying detected object image(s) in the interface for displaying the object image for search. For example, in the interface illustrated in FIG. 4, after the user selects and inputs an object image for search on the left side of the interface, and selects a designated region, the detected object image(s) acquired in step 305 can be displayed on the right side of the interface illustrated in FIG. 4.

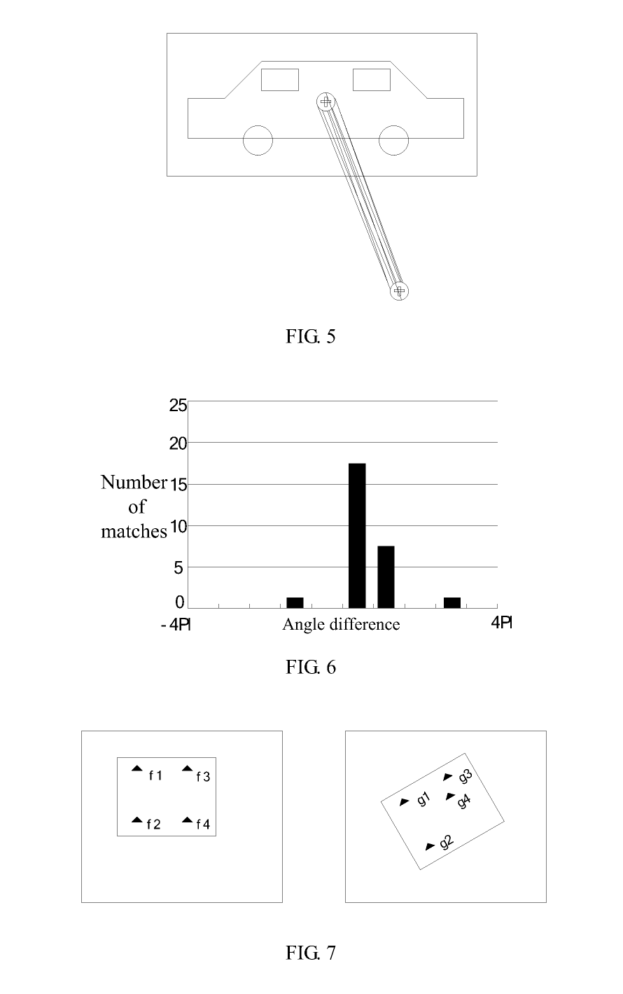

Furthermore, if one or more object images detected in the video completely match the object image for search, the SIFT point pairs therebetween are consistent in terms of angle difference and scale. Herein, a further description is given below by using the designated region of the object image for search and detected object image(s) illustrated in FIG. 5, and angle difference distribution illustrated in FIG. 6 as an example. As seen from the histogram illustrated in FIG. 6, four types of angle differences are calculated, where the majority of the angle differences fall into two types, mainly concentrate on two regions in the histogram, and the angle differences in other regions can be considered as angle differences generated by incorrect matching. Therefore, to remove unmatched search results, and further improve accuracy of object search, the method provided in this embodiment further supports verifying the detected object image(s). The specific verification method includes but is not limited to the following two:

Verification method 1: acquiring each SIFT point in the designated region and the corresponding SIFT point in each of the detected object image(s) to obtain an SIFT point pair; calculating an angle difference between two SIFT points in each SIFT point pair, and determining a primary angle difference in the calculated angle differences; and calculating a distance from each of the angle differences to the primary angle difference, and verify the detected object image(s) according to the distances.

Verification method 1 is described by using four SIFT points pairs (f1, g1), (f2, g2), (f3, g3), and (f4, g4) as an example. If two images are matched each other, the differences between SIFT points in each SIFT point pair are the same. As seen from FIG. 7, the positions of the two SIFT points in the SIFT point pair (f4, g4) in the two images are inconsistent; therefore, the angle difference between the two SIFT points is not equal to the angle difference between two SIFT points in any of other SIFT point pairs. During determination of a primary angle difference in the calculated angle differences, the angle difference with the maximum number of matches can be determined as the primary angle difference, and then the distance from each of the angle difference to the primary angle difference is calculated. Subsequently, one or more detected object images are verified according to the distances.

During the verification, the one or more detected object images are sorted according to the sum of the distances from each of the angle differences to the primary angle difference of each detected object image, or sorted according to the maximum distance of the distances from the angle differences to the primary angle difference of each detected object image; and a preset number of detected object images are selected from the sorted detected object images as a final search result. The detected object images may be sorted in ascending order or descending order, which is not limited in this embodiment. In addition, the preset number of selected detected object images is not limited in this embodiment either. A larger distance indicates a greater match error. Therefore, detected object images with smaller distances may be selected as object images passing the verification.

Verification method 2: acquiring each SIFT point in the designated region and the corresponding SIFT point in each of the detected object image(s) to obtain an SIFT point pair; calculating an angle difference between two SIFT points in each of any two SIFT point pairs, and calculating an angle formed by a line segment pair formed by the any two SIFT point pairs; judging whether the calculated angle differences are equal to the angle formed by the line segment pair, and if the calculated angle differences are equal to the angle formed by the line segment pair, using the any two SIFT point pairs as matched SIFT point pairs; and counting the number of matched SIFT point pairs in each of the detected object image(s), and verifying the detected object image(s) according to the number of matched SIFT point pairs in the detected object image(s).

For details about the second verification method, reference may be made to the description in Embodiment 3, which is not described herein any further.

According to the method provided in this embodiment, during object search, one or more object images are detected in a video by using SIFT points in a designated region of an object image for search, and the designated region is a discriminative region. In this way, object search is implemented by using a local region of an image, and thus the application range of the object search is extended. In addition, since calculation of the SIFT points is not subject to external factors such as illumination and the like, such that the object is effectively detected in the video, and accuracy of the search result is improved. Furthermore, after one or more object images are detected, these object images are verified. This removes unmatched object images, and further improves accuracy of the search result.

### Embodiment 3

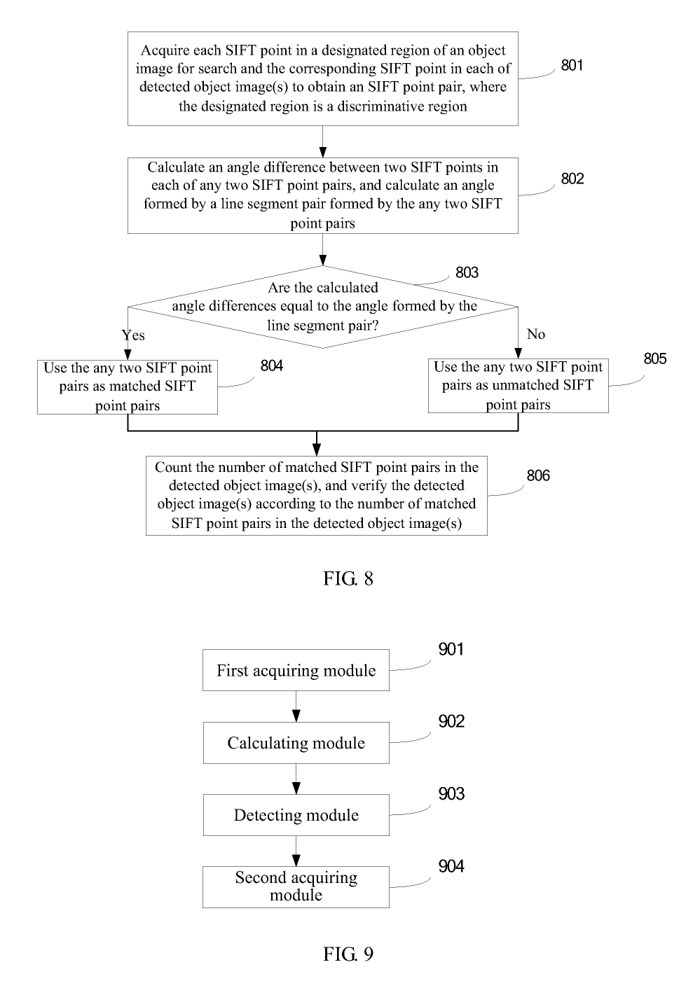

This embodiment provides a search verification method. With reference to the description in Embodiment 1, this embodiment uses verification on the search result acquired by using the object search method provided in Embodiment 2 as an example for description. For ease of description, this embodiment uses SIFT points as an example. Referring to FIG. 8, the method provided in this embodiment includes the following steps:

801: Acquiring each SIFT point in a designated region of an object image for search and the corresponding SIFT point of the detected object image(s) to acquire an SIFT point pair, where the designated region is a discriminative region.

For details about acquiring the object image for search, the designated region of the object image for search, and SIFT points in the designated region, reference may be made to the description in step 303 in Embodiment 2, which are not described herein any further. The one or more detected object images are object images detected in the video by using the object search method provided in Embodiment 2. Therefore, prior to the acquiring each SIFT points in the designated region of the object image for search and the corresponding SIFT point in each of the detected object image(s), the method further includes the following steps:

acquiring an object image for search and a designated region of the object image for search, and calculating SIFT points in the designated region of the object image for search, where the designated region is a discriminative region selected by a user over a GUI;

searching in a pre-constructed index set for index(es) matching the SIFT points in the designated region, where the index set is constructed according to SIFT points in object images in a video; and

acquiring object image(s) corresponding to the detected index(es), and using the acquired object image(s) as object image(s) detected in the video.

Furthermore, prior to the searching in a pre-constructed index set for index(es) matching the SIFT points in the designated region, the method further includes:

acquiring object images in a video, and calculating SIFT points in the object images; and

clustering the acquired SIFT points, and constructing an index set by using SIFT points at clustering centers as indexes.

Particularly, the searching in a pre-constructed index set for index(es) matching the SIFT points in the designated region specifically includes:

clustering the SIFT points in the designated region with the SIFT points in the index set, and using the SIFT points, which fall into the same category as the SIFT points in the designated region, in the index set as the detected SIFT points matching the SIFT points in the designated region.

For details about acquiring the detected object image(s), reference may be made to the description in Embodiment 2, which is not described herein any further.

802: Calculating an angle difference between two SIFT points in each of any two SIFT point pairs, and calculating an angle formed by a line segment pair formed by the any two SIFT point pairs.

With respect to this step, for ease of description, angle differences between SIFT points in two SIFT point pairs (f1, g1) and (f4, g4) in four SIFT point pairs (f1, g1), (f2, g2), (f3, g3), and (f4, g4) illustrated in FIG. 7, and an angle formed by a line segment pair formed by the two SIFT point pairs are used an example for description. The angle differences and the angle are expressed by the following formulas:

SIFTAngle(f1)−SIFTAngle(g1);

SIFTAngle(f4)−SIFTAngle(g4);

Angle(f1f4,g1g4);

“SIFTAngle(f1)−SIFTAngle(g1)” denotes an angle difference between f1 and g1, “SIFTAngle(f4)−SIFTAngle(g4)” denotes an angle difference between f4 and g4, and “Angle(f1f4, g1g4)” denotes an angle formed by a line segment pair formed by a line segment formed by f1 and f4 and a line segment formed by g1 and g4. The angle differences and the angle can be acquired by using location, scale and direction of the SIFT points. Calculation of the angle formed by the line segment pair uses a relative location relationship of the SIFT points, and uses more spatial information. Therefore, verification performance is improved.

803: Judging whether the calculated angle differences are equal to the calculated angle formed by the line segment pair, if equal, performing step 804, and otherwise, performing step 805.

With respect to this step, whether the calculated angle differences are equal to the calculated angle formed by the line segment pair is judged because if the object image for search matches the detected object image, the angle differences between the SIFT points in any two SIFT point pairs in the two matched object images and the angle formed by the line segment pair formed by the any two SIFT point pairs in the two matched object images are the same. Therefore, if the judgment in this step indicates that the calculated angle differences are equal to the calculated angle formed by the line segment pair, step 804 is performed; otherwise, step 805 is performed.

804: Using the any two SIFT point pairs as matched SIFT point pairs, and performing step 806.

If it is determined in step 803 that the angle differences acquired in step 802 are equal to the angle formed by the line segment pair, the any two SIFT point pairs are used as matched SIFT point pairs.

805: Using the any two SIFT point pairs as unmatched SIFT point pairs.

If it is determined in step 803 that the angle differences acquired in step 802 are not equal to the angle formed by the line segment pair, the any two SIFT point pairs are used as unmatched SIFT point pairs.

806: Counting the number of matched SIFT point pairs in the detected object image(s), and verifying the detected object image(s) according to the number of matched SIFT point pairs in the detected object image(s).

With respect to this step, matching judgment is performed for any two SIFT point pairs in the detected object image(s) according to steps 802 and 803 such that the number of matched SIFT point pairs in each of the detected object image(s) is counted, and the one or more detected object images are verified according to the number of matched SIFT point pairs.

During the verification, one or more detected object images are sorted according to the number of matched SIFT point pairs, and a preset number of detected object images are selected from the sorted object images as object images passing the verification. When the one or more detected object images are sorted according to the number of matched SIFT point pairs, they can be sorted in ascending order, or sorted in descending order, which is not limited in this embodiment. In addition, the preset number of selected object images is not limited in this embodiment either. A smaller number of matched SIFT point pairs indicates a greater match error; and a larger number of matched SIFT point pair indicates a smaller match error. Therefore, object image(s) with a larger number of matched SIFT point pairs may be selected as object image(s) passing the verification.

Furthermore, with respect to the object image(s) passing the verification, the method provided in this embodiment further supports displaying the object image(s). The object image(s) may be displayed in various ways, which is not limited in this embodiment.

It should be noted that, the search verification method provided in this embodiment further verifies object image(s) detected by using other object search methods in addition to verifying the object image(s) detected by using the object search method provided in Embodiment 1 or Embodiment 2. This embodiment sets no limitation on acquiring the detected object image(s) for verification.

According to the search verification method provide in this embodiment, an angle difference between two SIFT points in each of any two SIFT point pairs, and an angle formed by a line segment pair formed by the any two SIFT point pairs are calculated, matched SIFT point pairs are acquired accordingly, and then the one or more detected object images verified according to the number of matched SIFT point pairs. In this way, under the premise of reducing calculation complexity, a relative location relationship between the SIFT points is effectively used, and thus verification performance is improved.

### Embodiment 4

This embodiment provides an object search apparatus, wherein the apparatus is configured to perform the object search method provided in Embodiments 1 to 2. Referring to FIG. 9, the apparatus includes:

a first acquiring module 901, configured to acquire an object image for search and a designated region of the object image for search, where the designated region is a discriminative region;

a calculating module 902, configured to calculate local feature points in the designated region of the object image for search acquired by the first acquiring module 901;

a detecting module 903, configured to search in a pre-constructed index set for index(es) matching the local feature points in the designated region calculated by the calculating module 902, where the index set is constructed according to local feature points in object images in a video; and

a second acquiring module 904, configured to acquire object image(s) corresponding to the index(es) detected by the detecting module 903, and use the acquired object image(s) as object image(s) detected in the video.

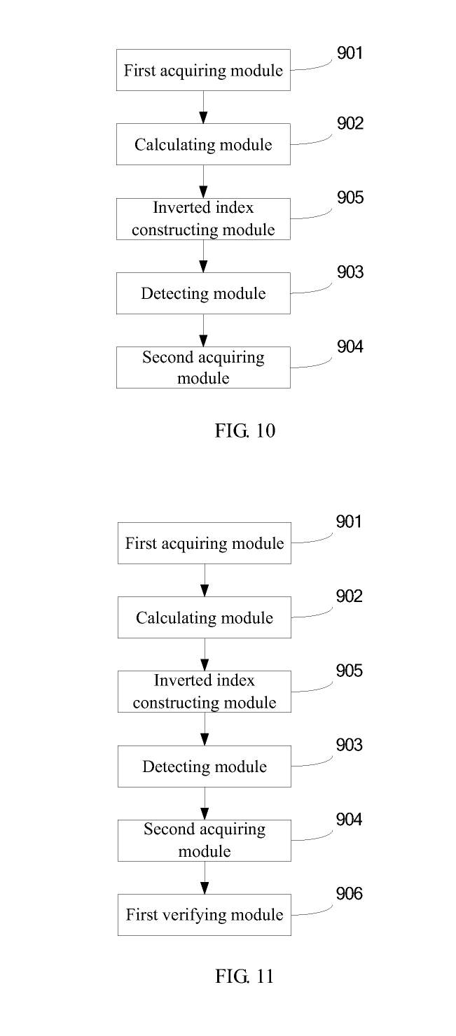

Referring to FIG. 10, the apparatus includes:

an index set constructing module 905, configured to: acquire object images in a video, and calculate local feature points in the object images; and cluster the acquired local feature points, and construct an index set by using local feature points at clustering centers as indexes.

The detecting module 903 is specifically configured to cluster the local feature points in the designated region with the local feature points in the index set, and use the local feature points, which fall into the same category as the local feature points in the designated region, in the index set as the detected index(es) matching the local feature points in the designated region.

Furthermore, referring to FIG. 11, the apparatus further includes:

a first verifying module 906, configured to: acquire each local feature point in the designated region and the corresponding local feature point in each of the detected object image(s) to obtain a local feature point pair; calculate an angle difference between two local feature points in each of the local feature point pairs, and determine a primary angle difference in the calculated angle differences; and calculate a distance from each of the angle differences to the primary angle difference, and verify the detected object image(s) according to the distances.

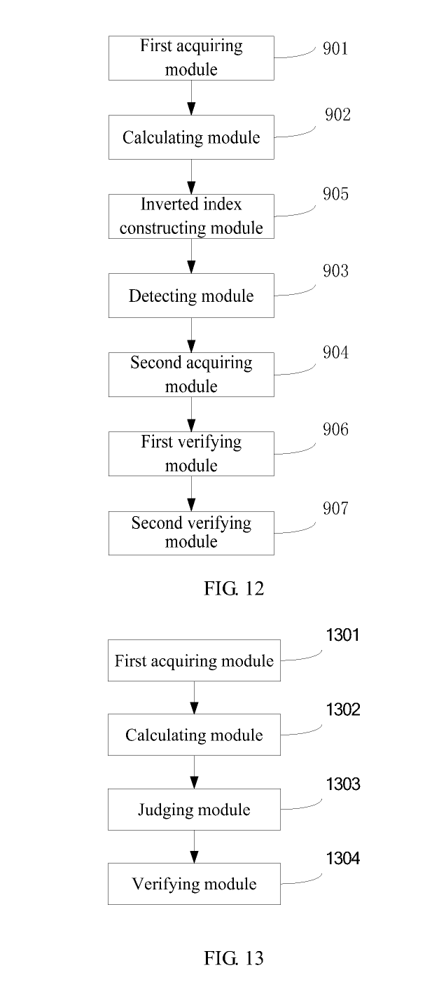

Furthermore, referring to FIG. 12, the apparatus further includes:

a second verifying module 907, configured to: acquire each local feature point in the designated region and the corresponding local feature point in each of the detected object image(s) to obtain a local feature point pair; calculate an angle difference between two local feature points in each of any two local feature point pairs, and calculate an angle formed by a line segment pair formed by the any two local feature point pairs; judge whether the calculated angle differences are equal to the angle formed by the line segment pair, and if the calculated angle differences are equal to the angle formed by the line segment pair, use the any two local feature point pairs as matched local feature point pairs; and count the number of matched local feature point pairs in the detected object images, and verify the detected object image(s) according to the number of matched local feature point pairs in the detected object image(s).

Furthermore, the apparatus further includes:

a first GUI, configured to display the object image for search, and the designated region of the object image for search acquired by the first acquiring module 901.

Furthermore, the apparatus further includes:

a second GUI, configured to display the object image(s) acquired by the second acquiring module 904.

Furthermore, the apparatus further includes:

a third GUI, configured to display the object image(s) successfully verified by the first verifying module 906 and the second verifying module 907.

According to the apparatus provided in this embodiment, during object search, one or more object images are detected in a video by using local feature points in designated region of an object image for search, and the designated region is a discriminative region. In this way, object search is implemented by using local regions of an image, and thus the application range of the object search is extended. In addition, since calculation of the local feature points is not subject to external factors such as illumination and the like, such that the object is effectively detected in the video, and accuracy of the search result is improved. Furthermore, after one or more object images are detected, these object images are verified. This removes unmatched object images, and further improves accuracy of the search result.

### Embodiment 5

This embodiment provides an object search apparatus, wherein the apparatus is configured to perform the object search method provided in Embodiments 1 to 3. Referring to FIG. 13, the apparatus includes:

a first acquiring module 1301, configured to acquire each local feature points in a designated region of an object image for search and the corresponding local feature point in each of detected object image(s) to acquire a local feature point pair, where the designated region is a discriminative region;

a calculating module 1302, configured to calculate an angle difference between two local feature points in each of any two local feature point pairs acquired by the first acquiring module 1301, and calculate an angle formed by a line segment pair formed by the any two local feature point pairs;

a judging module 1303, configured to judge whether the angle differences calculated by the calculating module 1302 are equal to the angle formed by the line segment pair;

a verifying module 1304, configured to: if the calculated angle differences are equal to the angle formed by the line segment pair, use the any two local feature point pairs as matched local feature point pairs; count the number of matched local feature point pairs in the detected object image(s); and verify the detected object images according to the number of matched local feature point pairs in the detected object image(s).

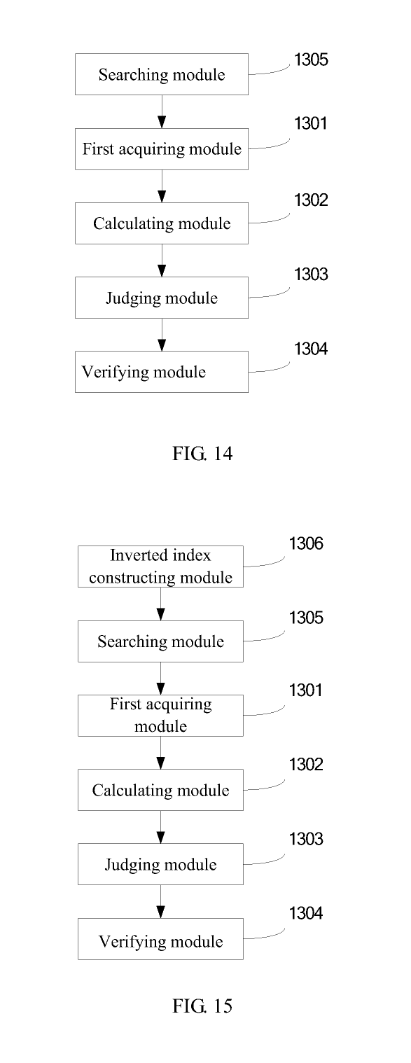

Furthermore, referring to FIG. 14, the apparatus further includes:

a searching module 1305, configured to: acquire an object image for search and a designated region of the object image for search, and calculate local feature points in the designated region of the object image for search; search in a pre-constructed index set for index(es) matching the local feature points in the designated region, where the index set is constructed according to local feature points in object images in a video; and acquire object image(s) corresponding to the detected index(es), and use the acquired object image(s) as object image(s) detected in the video.

Furthermore, referring to FIG. 15, the apparatus further includes:

an index set constructing module 1306, configured to: acquire object images in a video, and calculate local feature points in the object images; and cluster the acquired local feature points, and construct an index set by using local feature points at clustering centers as indexes.

The searching module 1305 is specifically configured to cluster the local feature points in the designated region with the local feature points in the index set, and use the local feature points, which fall into the same category as the local feature points in the designated region, in the index set as the detected index(es) matching the local feature points in the designated region.

Furthermore, the apparatus further includes:

a fourth GUI, configured to display the object image for search, and the designated region of the object image for search acquired by the searching module 1305.

Furthermore, the apparatus further includes:

a fifth GUI, configured to display the object image(s) detected by the searching module 1305.

Furthermore, the apparatus further includes:

a fifth GUI, configured to display the object image(s) successfully verified by the verifying module 1304.

According to the search verification apparatus provided in this embodiment, an angle difference between two local feature points in each of any two local feature point pairs, and an angle formed by a line segment pair formed by the any two local feature point pairs are calculated, matched local feature point pairs are acquired accordingly, and then one or more detected object images are verified according to the number of matched local feature points pairs. In this way, under the premise of reducing calculation complexity, a relative location relationship between the local feature points is effectively used, and thus verification performance is improved.

It should be noted that, during object search performed by the object search apparatus provided in the above embodiments, the apparatus according to the above embodiments is described by only using division of the above functional modules as an example. In practice, the functions may be assigned to different functional modules for implementation as required. To be specific, the internal structure of the apparatus is divided into different functional modules to implement all or part of the above-described functions. In addition, according to the above embodiments, the object search apparatus and the object search method pertain to the same concept, and the search verification apparatus and the search verification method pertain to the same concept. For details about the specific implementation, reference may be made to the method embodiments, which are not described herein any further.

The sequence numbers of the preceding embodiments of the present invention are only for ease of description, but do not denote the preference of the embodiments.

A person skilled in the art should understand that all or part of the steps of the preceding methods may be implemented by hardware or hardware following instructions of programs. The programs may be stored in a computer readable storage medium. The storage medium may be a read only memory, a magnetic disk, or a compact disc-read only memory.

Described above are merely preferred embodiments of the present invention, but are not intended to limit the present invention. Any modification, equivalent replacement, or improvement made without departing from the spirit and principle of the present invention should fall within the protection scope of the present invention.

What is claimed is:

1. An object search method, comprising:
acquiring an object image for search and a designated region of the object image for search, and calculating local feature points in the designated region of the object image for search, wherein the designated region is a discriminative region;
searching in a pre-constructed index set for one or more indexes matching the local feature points in the designated region, wherein the index set is constructed according to local feature points in object images in a video; and
acquiring one or more object images corresponding to detected indexes, and using the one or more object images as object images detected in the video.

2. The method according to claim 1, wherein prior to the searching in a pre-constructed index set for one or more indexes matching the local feature points in the designated region, the method further comprises:
acquiring object images in a video, and calculating local feature points in the object images; and
clustering the acquired local feature points, and constructing an index set by using local feature points at clustering centers as indexes.

3. The method according to claim 1, wherein the searching in a pre-constructed index set for one or more indexes matching the local feature points in the designated region specifically comprises:
clustering the local feature points in the designated region with the local feature points in the index set, and using the local feature points, which fall into the same category as the local feature points in the designated region, in the index set as the detected indexes matching the local feature points in the designated region.

4. The method according to claim 1, wherein after acquiring the one or more object images corresponding to the detected indexes, and using the acquired object images as object images detected in the video, the method further comprises:
acquiring each local feature point in the designated region and the corresponding local feature point in each of the detected object images to obtain a local feature point pair;
calculating an angle difference between two local feature points in each of the local feature point pairs, and determining a primary angle difference in the calculated angle differences; and
calculating a distance from each of the angle differences to the primary angle difference, and verifying the detected object images according to the distances.

5. The method according to claim 1, wherein after the acquiring object images corresponding to the detected indexes, and using the acquired object images as object images detected in the video, the method further comprises:
acquiring each local feature point in the designated region and the corresponding local feature point in each of the detected object images to obtain a local feature point pair;
calculating an angle difference between two local feature points in each of any two local feature point pairs, and calculating an angle formed by a line segment pair formed by the any two local feature point pairs;
judging whether the calculated angle differences are equal to the angle formed by the line segment pair, and if the calculated angle differences are equal to the angle formed by the line segment pair, using the any two local feature point pairs as matched local feature point pairs; and
counting the number of matched local feature point pairs in the detected object images, and verifying the detected object images according to the number of matched local feature point pairs in the detected object images.

6. The method according to claim 1, wherein after the acquiring an object image for search, the method further comprises:
displaying the object image for search, and the designated region of the object image for search.

7. The method according to claim 1, wherein after the acquiring object images corresponding to the detected index(es), and using the acquired object images as object images detected in the video, the method further comprises:
displaying detected object images.

8. The method according to claim 4, further comprising:
displaying object image(s) passing verification.

9. An object search apparatus, comprising:
a first acquiring module, configured to acquire an object image for search and a designated region of the object image for search, wherein the designated region is a discriminative region;
a calculating module, configured to calculate local feature points in the designated region of the object image for search acquired by the first acquiring module;
a detecting module, configured to search in a pre-constructed index set for one or more indexes matching the local feature points in the designated region calculated by the calculating module, wherein the index set is constructed according to local feature points in object images in a video; and
a second acquiring module, configured to acquire one or more object images corresponding to the indexes detected by the detecting module, and use acquired object images as object images detected in the video.

10. The apparatus according to claim 9, further comprising:
an index set constructing module, configured to: acquire object images in a video, and calculate local feature points in the object images; and cluster the acquired local feature points, and construct an index set by using local feature points at clustering centers as indexes.

11. The apparatus according to claim 9, wherein the detecting module is specifically configured to cluster the local feature points in the designated region with the local feature points in the index set, and use the local feature points, which fall into the same category as the local feature points in the designated region, in the index set as the detected index(es) matching the local feature points in the designated region.

12. The apparatus according to claim 9, further comprising:
a first verifying module, configured to: acquire each local feature point in the designated region and the corresponding local feature point in each of the detected object images to obtain a local feature point pair; calculate an angle difference between two local feature points in each of the local feature point pairs, and determine a primary angle difference in the calculated angle differences; and calculate a distance from each of the angle differences to the primary angle difference, and verify the detected object images according to the distances.

13. The apparatus according to claim 9, further comprising:
a second verifying module, configured to: acquire each local feature point in the designated region and the corresponding local feature point in each of the detected object images to obtain a local feature point pair; calculate an angle difference between two local feature points in each of any two local feature point pairs, and calculate an angle formed by a line segment pair formed by the any two local feature point pairs; judge whether the calculated angle differences are equal to the angle formed by the line segment pair, and if the calculated angle differences are equal to the angle formed by the line segment pair, use the any two local feature point pairs as matched local feature point pairs; and count the number of matched local feature point pairs in the detected object images, and verify the detected object images according to the number of matched local feature point pairs in the detected object images.

14. The apparatus according to claim 9, further comprising:
a first GUI, configured to display the object image for search, and the designated region of the object image for search acquired by the first acquiring module.

15. The apparatus according to claim 9, further comprising:
a second GUI, configured to display the object images acquired by the second acquiring module.

16. The apparatus according to claim 13, further comprising:
a third GUI, configured to display object images successfully verified by the first verifying module and the second verifying module.

17. A search verification method, comprising:
acquiring each local feature point in a designated region of an object image for search and the corresponding local feature point in each of detected object images to obtain a local feature point pair, wherein the designated region is a discriminative region;
calculating an angle difference between two local feature points in each of any two local feature point pairs, and calculating an angle formed by a line segment pair formed by the any two local feature point pairs;
judging whether the calculated angle differences are equal to the angle formed by the line segment pair, and if the calculated angle differences are equal to the angle formed by the line segment pair, using the any two local feature point pairs as matched local feature point pairs; and
counting the number of matched local feature point pairs in the detected object images, and verifying the detected object images according to the number of matched local feature point pairs in the detected object images.

18. The method according to claim 17, wherein prior to the acquiring local feature points in a designated region of an object image for search and the corresponding local feature points in detected object images, the method further comprises:
acquiring the object image for search and the designated region of the object image for search, and calculating the local feature points in the designated region of the object image for search;
searching in a pre-constructed index set for one or more indexes matching the local feature points in the designated region, wherein the index set is constructed according to local feature points in object images in a video; and
acquiring one or more object images corresponding to the detected indexes, and using acquired object images as object images detected in the video.

19. The method according to claim 18, wherein prior to the searching in a pre-constructed index set for indexes matching the local feature points in the designated region, the method further comprises:
acquiring object images in a video, and calculating the local feature points in the object images; and
clustering the acquired local feature points, and constructing an index set by using local feature points at clustering centers as indexes.

20. The method according to claim 19, wherein the searching in a pre-constructed index set for indexes matching the local feature points in the designated region specifically comprises:
clustering the local feature points in the designated region with the local feature points in the index set, and using the local feature points, which fall into the same category as the local feature points in the designated region, in the index set as the detected indexes matching the local feature points in the designated region.

21. A search verification apparatus, comprising:
a first acquiring module, configured to acquire each local feature point in a designated region of an object image for search and the corresponding local feature point in each of detected object images to obtain a local feature point pair, wherein the designated region is a discriminative region;
a calculating module, configured to calculate an angle difference between two local feature points in each of any two local feature point pairs acquired by the first acquiring module, and calculate an angle formed by a line segment pair formed by the any two local feature point pairs;
a judging module, configured to judge whether the angle differences calculated by the calculating module are equal to the angle formed by the line segment pair; and
a verifying module, configured to: if the calculated angle differences are equal to the angle formed by the line segment pair, use the any two local feature point pairs as matched local feature point pairs; count the number of matched local feature point pairs in the detected object image(s); and verify the detected object images according to the number of matched local feature point pairs in the detected object image(s).

22. The apparatus according to claim 21, further comprising:
a searching module, configured to: acquire an object image for search and a designated region of the object image for search, and calculate local feature points in the designated region of the object image for search; search in a pre-constructed index set for indexes matching the local feature points in the designated region, wherein the index set is constructed according to local feature points in object images in a video; and acquire object images corresponding to the detected indexes, and use the acquired object images as object images detected in the video.

23. The apparatus according to claim 22, further comprising:
an index set constructing module, configured to acquire object images in a video, and calculate local feature points in the object images; and cluster the acquired local feature points, and construct an index set by using local feature points at clustering centers as indexes.

24. The apparatus according to claim 22, wherein the searching module is specifically configured to cluster the local feature points in the designated region with the local feature points in the index set, and use the local feature points, which fall into the same category as the local feature points in the designated region, in the index set as the detected indexes matching the local feature points in the designated region.
